(19) United States
(12) Patent Application Publication
(10) Pub. No.: US 2012/0278175 A1
(43) Pub. Date: Nov. 1, 2012

(54) METHODS AND ARRANGEMENTS FOR MONETIZING TELECOM APP-STORES THROUGH NETWORK API USAGE

(75) Inventors: Vikas Agarwal, New Delhi (IN); Sumit Mittal, Uttar Pradesh (IN); Sougata Mukherjea, New Delhi (IN)

(73) Assignee: INTERNATIONAL BUSINESS MACHINES CORPORATION, Armonk, NY (US)

(21) Appl. No.: 13/097,111

(22) Filed: Apr. 29, 2011

(51) Int. Cl. G06Q 30/00

(52) U.S. Cl. 705/14.64

(57) ABSTRACT

Methods and arrangements for monetizing telecom application. Advertising input is accepted, as well as contractual input relating to advertisement dissemination. An advertisement is associated with a telecom customer based on matchmaking criteria, and the advertisement is output to the customer based on the contractual input. This outputting includes propagating the advertisement selectively via at least one of: an in-application channel, wherein the advertisement is associated with a telecom application used by the customer; and an out-of-application channel, wherein the advertisement is propagated directly to the customer.

### BACKGROUND

New generations of mobile phones, e.g., those compatible with 3G or 4G networks, have lead to explosive growth in applications, or “apps” for those phones. Mobile phone manufacturers now offer application stores, or app stores, where a customer can purchase apps for their phones. App stores, however, are usually distinct from the associated telecoms (or telecom operators), and telecoms have not been able to benefit greatly from this separate arrangement.

### BRIEF SUMMARY

In summary, one aspect of the invention provides a method comprising: accepting advertising input; accepting contractual input relating to advertisement dissemination; associating an advertisement with a telecom customer based on matchmaking criteria; and outputting the advertisement to the customer based on the contractual input; the outputting comprising propagating the advertisement selectively via at least one of: an in-application channel, wherein the advertisement is associated with a telecom application used by the customer; and an out-of-application channel, wherein the advertisement is propagated directly to the customer.

Another aspect of the invention provides an apparatus comprising: at least one processor; and a computer readable storage medium having computer readable program code embodied therewith and executable by the at least one processor, the computer readable program code comprising: computer readable program code configured to accept advertising input; computer readable program code configured to accept contractual input relating to advertisement dissemination; computer readable program code configured to associate an advertisement with a telecom customer based on matchmaking criteria; computer readable program code configured to output the advertisement to the customer based on the contractual input; and computer readable program code configured to output the advertisement selectively via at least one of: an in-application channel, wherein the advertisement is associated with a telecom application used by the customer; and an out-of-application channel, wherein the advertisement is propagated directly to the customer.

An additional aspect of the invention provides a computer program product comprising: a computer readable storage medium having computer readable program code embodied therewith, the computer readable program code comprising: computer readable program code configured to accept advertising input; computer readable program code configured to accept contractual input relating to advertisement dissemination; computer readable program code configured to associate an advertisement with a telecom customer based on matchmaking criteria; computer readable program code configured to output the advertisement to the customer based on the contractual input; and computer readable program code configured to output the advertisement selectively via at least one of: an in-application channel, wherein the advertisement is associated with a telecom application used by the customer; and an out-of-application channel, wherein the advertisement is propagated directly to the customer.

For a better understanding of exemplary embodiments of the invention, together with other and further features and advantages thereof, reference is made to the following description, taken in conjunction with the accompanying drawings, and the scope of the claimed embodiments of the invention will be pointed out in the appended claims.

### BRIEF DESCRIPTION OF THE SEVERAL VIEWS OF THE DRAWINGS

FIG. 1 illustrates a computer system.

FIG. 2 schematically illustrates an application monetization arrangement.

FIG. 3 illustrates a structured ad.

FIG. 4 sets forth a process more generally for monetizing telecom applications.

### DETAILED DESCRIPTION

It will be readily understood that the components of the embodiments of the invention, as generally described and illustrated in the figures herein, may be arranged and designed in a wide variety of different configurations in addition to the described exemplary embodiments. Thus, the following more detailed description of the embodiments of the invention, as represented in the figures, is not intended to limit the scope of the embodiments of the invention, as claimed, but is merely representative of exemplary embodiments of the invention.

Reference throughout this specification to “one embodiment” or “an embodiment” (or the like) means that a particular feature, structure, or characteristic described in connection with the embodiment is included in at least one embodiment of the invention. Thus, appearances of the phrases “in one embodiment” or “in an embodiment” or the like in various places throughout this specification are not necessarily all referring to the same embodiment.

Furthermore, the described features, structures, or characteristics may be combined in any suitable manner in at least one embodiment. In the following description, numerous specific details are provided to give a thorough understanding of embodiments of the invention. One skilled in the relevant art will recognize, however, that the various embodiments of the invention can be practiced without at least one of the specific details, or with other methods, components, materials, et cetera. In other instances, well-known structures, materials, or operations are not shown or described in detail to avoid obscuring aspects of the invention.

The description now turns to the figures. The illustrated embodiments of the invention will be best understood by reference to the figures. The following description is intended only by way of example and simply illustrates certain selected exemplary embodiments of the invention as claimed herein.

It should be noted that the flowchart and block diagrams in the figures illustrate the architecture, functionality, and operation of possible implementations of systems, apparatuses, methods and computer program products according to various embodiments of the invention. In this regard, each block in the flowchart or block diagrams may represent a module, segment, or portion of code, which comprises at least one executable instruction for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

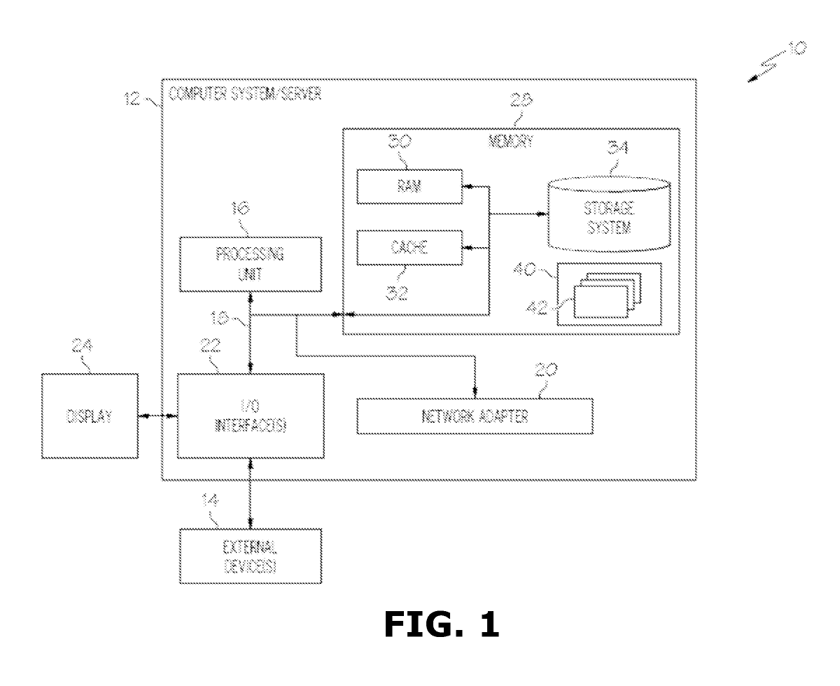

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove. In accordance with embodiments of the invention, computing node 10 may not necessarily even be part of a cloud network but instead could be part of another type of distributed or other network, or could represent a stand-alone node. For the purposes of discussion and illustration, however, node 10 is variously referred to herein as a “cloud computing node”.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, at least one processor or processing unit 16, a system memory 28, and a bus 18 that couples various system components including system memory 28 to processor 16.

Bus 18 represents at least one of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by at least one data media interface. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, at least one application program, other program modules, and program data. Each of the operating system, at least one application program, other program modules, and program data or some combination thereof, may include an implementation of a networking environment. Program modules 42 generally carry out the functions and/or methodologies of embodiments of the invention as described herein.

Computer system/server 12 may also communicate with at least one external device 14 such as a keyboard, a pointing device, a display 24, etc.; at least one device that enable a user to interact with computer system/server 12; and/or any devices (e.g., network card, modem, etc.) that enable computer system/server 12 to communicate with at least one other computing device. Such communication can occur via I/O interfaces 22. Still yet, computer system/server 12 can communicate with at least one network such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

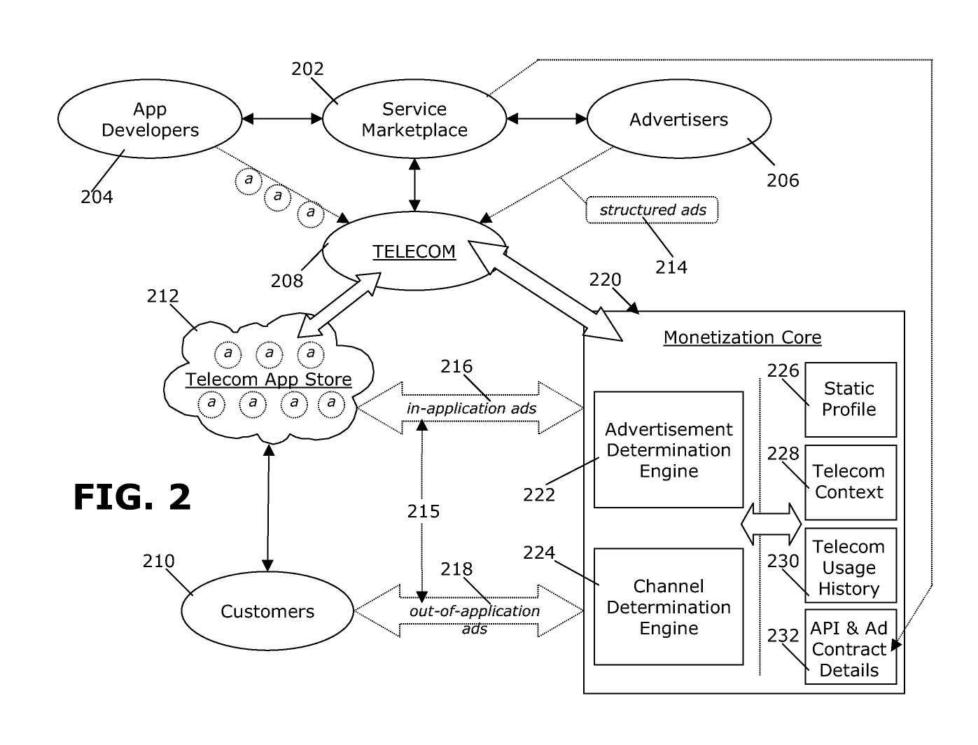

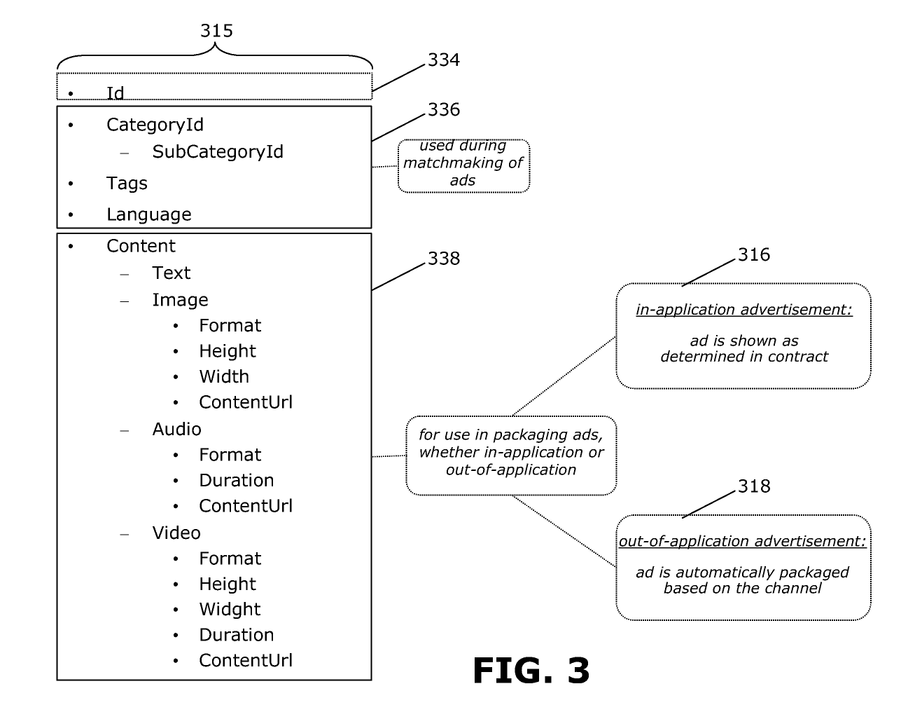

The disclosure now turns to FIGS. 2 and 3. It should be appreciated that the processes, arrangements and products broadly illustrated therein can be carried out on or in accordance with essentially any suitable computer system or set of computer systems, which may, by way of an illustrative and non-restrictive example, include a system or server such as that indicated at 12 in FIG. 1. In accordance with an example embodiment, most if not all of the process steps, components and outputs discussed with respect to FIGS. 2 and 3 can be performed or utilized by way of a processing unit or units and system memory such as those indicated, respectively, at 16 and 28 in FIG. 1, whether on a server computer, a client computer, a node computer in a distributed network, or any combination thereof.

To facilitate easier reference, in advancing from FIG. 2 to and through FIG. 3, in FIG. 3 a reference numeral is advanced by a multiple of 100 in indicating a substantially similar or analogous component or element with respect to at least one component or element found in FIG. 2.

In accordance with at least one embodiment of the invention, it is recognized that telecoms tend to have API's (application programming interfaces), such as reading location of a user, sending an SMS, establishing a third-party call, etc. associated therewith that can be exposed for usage within applications offered via app stores. (“AppStore” is a trademark of Apple Inc., of Cupertino, Calif., while herein the term “app store” is used generically.) Such API's are typically versatile enough as to be usable across different devices and different varieties of programming languages, such as C, Java, JavaScript, etc. Accordingly, successfully harnessing and managing this capability can provide an effective monetization through app stores, whereby telecoms can take advantage of the very high traffic already associated with the proliferation of apps.

Thus, there is broadly contemplated herein, in accordance with at least one embodiment of the invention, methods and arrangements for piggybacking ads and billing with telecom API usage. As such, telecom API's can be extended or adapted to permit support for different models for monetizing API usage. In an explicit model, a customer pays for API usage, where advertising (ads) may not be necessary. In an implicit model, however, there would be no charge for API usage while a customer indeed could be shown advertisements. In taking advantage of the high traffic volume of apps, an app developer, per a contract, can show ads in the context of its apps by way of the telecom offering “in-application” ads. On the other hand, in “out-of-application” ads, the telecom would send ads to a customer separately via a relevant channel such as voice call, SMS, MMS, etc.

As shown in the arrangement of FIG. 2, broadly contemplated herein, in accordance with at least one embodiment of the invention, is the use of a service marketplace 202 between different participants. In such a marketplace, advertisers 206 can bid for various telecom-specific parameters (e.g., locations, user profiles, etc.), while app developers 204 can contract with a telecom 208 on how ads 214 will be shown in the former's apps (a) and thereby get or negotiate a share of the advertising revenues based on app usage. As shown, a telecom app store 212 is associated with the telecom 208, whereby apps (a) are made available to customers 210. Also associated with telecom 208 is a monetization core 220 which associates ads with API's and then serves to disseminate ads. Accordingly, and in a manner to be more fully appreciated herebelow, there is provided an overall architecture for advertisements and promotions that effectively leverages a telecom's (208) unique position to send out customer-relevant ads (based on information normally only available to the telecom) and to use essentially any suitable channel for the purpose (e.g., SMS, voice, web).

Elaborating further, in accordance with at least one embodiment of the invention, app developers 204 create apps that are hosted at the app store 212, and these can include native and mobile web applications that are configured to make use of the extended API's discussed herethroughout. Customers (or users) 210 access or download applications hosted at the app-store 212 and in that connection receive advertisements and promotions, whether these are in an in-application (216) or out-of-application (218) context. Advertisers 206, in the service marketplace 202, work with the telecom 208 to develop and send advertisements and promotions and wrap their content in structured format.

Elaborating even further, in accordance with at least one embodiment of the invention, the telecom app-store 212 includes apps (a) that can be downloaded by customers 210 onto their mobile phones or that can be accessed via web through the telecom's (208) website.

In accordance with at least one embodiment of the invention, telecom API's are extended to accept structured input and then output (from monetization core 220) distinct monetization objects. The structured input is contained in the form of a structured ad input 214. The structured ad input 214 can include identifying information on the customer, app developer and on the app itself, as well as authentication information. API outputs 215, on the other hand, would contain ads that are passed outwardly in a structured format. Multiple programming styles are employable in the context of the API's. (It should be understood that, in the present example, even though a telecom API is called from within the app running on the mobile device or other device of a customer 210, it is actually a remote call that goes over a network to the telecom 208 and the response is sent by the telecom 208 back to the app.)

To elaborate by way of further non-restrictive illustration, in accordance with at least one example embodiment of the invention, an advertiser 206 provides an ad in structured format (214) to a telecom or telecom operator 208. When an app calls a telecom API, it passes along a customer/developer/application ID and authentication information as input. This information is used by the telecom 208 to determine how to undertake charging for this API. If explicit charging is to be involved, then no ad would be send but the customer 210 would be charged for using this API from within the app. However, if it is a free API, then the telecom 208 would determine an appropriate ad based on various types of information available with the ad, and send that ad, in structured fashion, as part of the output of this API.

In accordance with at least one embodiment of the invention, for in-application advertisement (216), there can be a requirement for the app developer to display the ad within the app in a manner specified by contract; the ad 216 is thus sent as output of the API call from within an app (a) running or accessed from the mobile phone of the customer 210. For out-of-application advertisement (218), the telecom operator can automatically package the ad based on the communication channel being used and send the ad directly to a customer 210. Advertisements and promotions can thereby be wrapped in a well-defined structured format, to permit appropriate packaging for different channels; an example of such a structured format will be better understood herebelow with respect to FIG. 3.

Monetization core 220, in accordance with at least one embodiment of the invention, employs a system for ad and channel determination, via engines 222 and 224, respectively. An ad or promotion determination engine 222 determines which customer is making an API request (e.g., through a phone number or a unique code generated at the time of application download). Channel determination engine 224 selects an appropriate channel (e.g., SMS, voice, web) for out-of-application ads 218 and serves to attach an ad to an API response for in-application ads 216. (As the API is called from within the app running on the mobile phone or other device of the customer 210, “response” here refers to the output of the API call.)

In accordance with at least one embodiment of the invention, within monetization core 220, four information blocks (e.g., in the form of databases) include: a static profile block 226, a telecom context block 228, a telecom usage history block 230 and a block 232 for API and advertiser contract details. In the context of blocks 226/228/230/232, a customer static profile (e.g., for age, gender, income, etc.) (226) can be captured when the user first registers with the telecom 208 for being availed of its services, and this information can be updated whenever such information is explicitly updated by the customer 210. Telecom context (228) can be automatically determined by the telecom 208 (e.g., location can inferred from the current tower with which a customer 210 is exchanging signals). Telecom usage history (230) can be built by the telecom 208 based on the usage of its services (e.g., number and duration of calls made, SMS texts sent, etc.) For block 232, API contract details can be provided by the telecom 208 while advertiser contract details can be populated via negotiation between telecom 208 and advertiser(s) 206.

In accordance with at least one embodiment of the invention, the static profile block 226 is used in general matchmaking, alluded to further above. Such matchmaking can proceed, by way of an illustrative and non-restrictive example, as follows. First telecom 208 determines whether an API is a “free” or “paid” API. In the case of the former, an ad is sent to customer 210 while, in the case of the latter, no ad is sent. Thence, if an ad is to be shown, then based on contract details a determination is made as to whether in-application ads (216) can be shown. If not, then a determination is made, via channel determination engine 224, as to the appropriate channel for showing an out-of-application ad 218 to the customer 210 (i.e., in an out-of-application ad 218), based on telecom usage history and other pertinent information. An appropriate ad is then selected, based on the channel determined as above, and based also on current user context and profile information.

The telecom context block 228 determines customer-related information such as a current location and status of a customer phone. The telecom usage history block 230 is used to determine which channel is most used by a particular user. The block 232 for API and advertiser contract details serves at least a twofold purpose: to determine whether ads need to be sent at all (e.g., based on a contract as discussed hereabove, for instance, as to whether a contract with a developer 204 is for paid or free API's), and, if yes, to ascertain whether the contract calls for an in-application or out-of-application ad; and to determine whether multiple ads are appropriate for a particular context and if an actual ad is adequately based on the contract with the corresponding advertisers. (Again, a telecom 208 can determine the best channel for sending an ad to a customer 210, based on the contract and also possibly on other information available, such as customer profile, usage history, etc.) Details relating to an ad, including contract details, can derive from agreements reached at the service marketplace 202. (Such information can be provided automatically from the marketplace 202, but manual provision of such information is also possible. Automatic provision, for its part, can follow from an advertiser 206 choosing from a discrete list or set of options offered by the telecom 208.)

Elaborating further, in accordance with at least one embodiment of the invention, based on information held in the blocks 226/228/230/232, relevant output ads 215 are determined via engine 222. Thus, static profile block 226 provides static information (e.g., demographics, user profile, etc.), while telecom context block 228 provides current context information (e.g., phone status information such as off-hook, on-hook, location, device). Telecom usage history block 230 provides historical information that can also be considered, while block 232 imparts information relating to advertiser and application developer contracts.

FIG. 3 illustrates the structure of an output ad 315, in accordance with at least one embodiment of the invention, which can be in the form of an in-application (316) or out-of-application (318) ad. A general ID 334 is present, as well as a section 336 used in ad matchmaking Section 336 can thus contain, for example, ID's for an ad category and/or subcategory, tags (i.e., keywords that further qualify the content of an advertisement) and the language of the ad. Such information can be advantageously matched with a particular customer or group of customers based on compatibility. An additional section 338 is used in packaging in-application (316) or out-of-application (318) contexts. Section 338 relates to the content of the ad, including (by way of example) information as shown, such as text, image, audio and video information. It should be appreciated that the ad structure 315 can readily apply to either an in-application (316) or out-of-application (318) context, wherein in the former context the ad is shown as determined in a contract with an app developer while in the former context the ad is automatically packaged based on the communication channel being used. (In accordance with at least one example embodiment of the invention, ads are sent as part of a response to an API call for in-application ads, and the ads end up being rendered or shown in an app UI [user interface] itself)

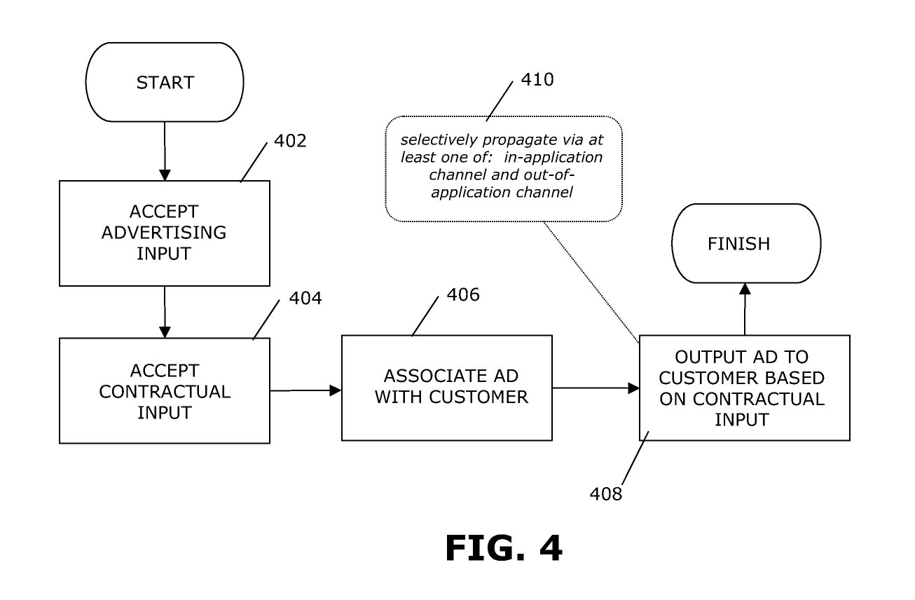

FIG. 4 sets forth a process more generally for monetizing telecom applications, in accordance with at least one embodiment of the invention. It should be appreciated that a process such as that broadly illustrated in FIG. 4 can be carried out on essentially any suitable computer system or set of computer systems, which may, by way of an illustrative and on-restrictive example, include a system such as that indicated at 12 in FIG. 1. In accordance with an example embodiment, most if not all of the process steps discussed with respect to FIG. 4 can be performed by way a processing unit or units and system memory such as those indicated, respectively, at 16 and 28 in FIG. 1.

As shown in FIG. 4, advertising input is accepted (402), as well as contractual input relating to advertisement dissemination (404). An advertisement is associated with a telecom customer based on matchmaking criteria (406), and the advertisement is output to the customer based on the contractual input (408). This outputting includes propagating the advertisement selectively (410) via at least one of: an in-application channel, wherein the advertisement is shown within a telecom application used by the customer; and an out-of-application channel, wherein the advertisement is propagated directly to the customer.

It should be noted that aspects of the invention may be embodied as a system, method or computer program product. Accordingly, aspects of the invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the invention may take the form of a computer program product embodied in at least one computer readable medium having computer readable program code embodied thereon.

Any combination of at least one computer readable medium may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having at least one wire, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire line, optical fiber cable, RF, etc., or any suitable combination of the foregoing.

Computer program code for carrying out operations for aspects of the invention may be written in any combination of at least one programming language, including an object oriented programming language such as Java®, Smalltalk, C++ or the like and conventional procedural programming languages, such as the “C” programming language or similar programming languages. The program code may execute entirely on the user's computer (device), partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

This disclosure has been presented for purposes of illustration and description but is not intended to be exhaustive or limiting. Many modifications and variations will be apparent to those of ordinary skill in the art. The embodiments were chosen and described in order to explain principles and practical application, and to enable others of ordinary skill in the art to understand the disclosure for various embodiments with various modifications as are suited to the particular use contemplated.

Although illustrative embodiments of the invention have been described herein with reference to the accompanying drawings, it is to be understood that the embodiments of the invention are not limited to those precise embodiments, and that various other changes and modifications may be affected therein by one skilled in the art without departing from the scope or spirit of the disclosure.

What is claimed is:

1. A method comprising:
accepting advertising input;
accepting contractual input relating to advertisement dissemination;
associating an advertisement with a telecom customer based on matchmaking criteria; and
outputting the advertisement to the customer based on the contractual input;
said outputting comprising propagating the advertisement selectively via at least one of:
an in-application channel, wherein the advertisement is associated with a telecom application used by the customer; and
an out-of-application channel, wherein the advertisement is propagated directly to the customer.

2. The method according to claim 1, wherein said associating comprises associating an advertisement with the usage of a telecom network application programming interface from within an application used by a telecom customer based on matchmaking criteria.

3. The method according to claim 1, wherein said outputting comprises propagating the advertisement via an in-application channel, wherein the advertisement is shown within a telecom application used by the customer.

4. The method according to claim 1, further comprising expanding a telecom network application programming interface to perform said associating and outputting steps.

5. The method according to claim 1, wherein said accepting of contractual input comprises accepting contractual input relating to the propagation of telecom applications.

6. The method according to claim 1, wherein said accepting of contractual input comprises accepting contractual input relating to the association of telecom applications with advertisements.

7. The method according to claim 1, wherein said propagating via an out-of-application channel comprises automatically packaging the advertisement based on a communication channel used with the customer.

8. The method according to claim 1, wherein the matchmaking criteria include at least one taken from the group consisting of: static customer information; current customer context information; a communication channel historically used by a customer.

9. The method according to claim 1, wherein said outputting comprises selecting between the at least one of an in-application channel and an out-of-application channel based on at least one taken from the group consisting of: contextual information relating to the customer; historical information relating to the customer.

10. The method according to claim 1, wherein said accepting of contractual input comprises accepting details relating to a contract between a telecom and an app developer.

11. The method according to claim 10, wherein said accepting of details comprises incorporating details relating to usage of at least one telecom network application programming interface from within an application.

12. The method according to claim 11, wherein said incorporating comprises determining the use of at least one taken from the group consisting of: a paid application programming interface; a free programming application interface.

13. The method according to claim 1, wherein said accepting of contractual input comprises accepting a specification which prescribes the use of the at least one of: an in-application channel and an out-of-application channel.

14. An apparatus comprising:
at least one processor; and
a computer readable storage medium having computer readable program code embodied therewith and executable by the at least one processor, the computer readable program code comprising:
computer readable program code configured to accept advertising input;
computer readable program code configured to accept contractual input relating to advertisement dissemination;
computer readable program code configured to associate an advertisement with a telecom customer based on matchmaking criteria;
computer readable program code configured to output the advertisement to the customer based on the contractual input; and
computer readable program code configured to output the advertisement selectively via at least one of:
an in-application channel, wherein the advertisement is associated with a telecom application used by the customer; and
an out-of-application channel, wherein the advertisement is propagated directly to the customer.

15. A computer program product comprising:
a computer readable storage medium having computer readable program code embodied therewith, the computer readable program code comprising:
computer readable program code configured to accept advertising input;
computer readable program code configured to accept contractual input relating to advertisement dissemination;
computer readable program code configured to associate an advertisement with a telecom customer based on matchmaking criteria;
computer readable program code configured to output the advertisement to the customer based on the contractual input; and
computer readable program code configured to output the advertisement selectively via at least one of:
an in-application channel, wherein the advertisement is associated with a telecom application used by the customer; and
an out-of-application channel, wherein the advertisement is propagated directly to the customer.

16. The computer program product according to claim 15, wherein said computer readable program code is configured to associate an advertisement with the usage of a telecom network application programming interface from within an application used by a telecom customer based on matchmaking criteria.

17. The computer program product according to claim 15, wherein said computer readable program code is configured to associate the advertisement via an in-application channel, wherein the advertisement is shown within a telecom application used by the customer.

18. The computer program product according to claim 15, wherein said computer readable program code is further configured to expand a telecom network application programming interface to perform said associating and outputting steps.

19. The computer program product according to claim 15, wherein said computer readable program code is configured to accept contractual input relating to the propagation of telecom applications.

20. The computer program product according to claim 15, wherein said computer readable program code is configured to accept contractual input relating to the association of telecom applications with advertisements.

21. The computer program product according to claim 15, wherein said computer readable program code is configured to propagate via an out-of-application channel via automatically packaging the advertisement based on a communication channel used with the customer.

22. The computer program product according to claim 15, wherein the matchmaking criteria include at least one taken from the group consisting of: static customer information; current customer context information; a communication channel historically used by a customer.

23. The computer program product according to claim 15, wherein said computer readable program code is configured to select between the at least one of an in-application channel and an out-of-application channel based on at least one taken from the group consisting of: contextual information relating to the customer; historical information relating to the customer.

24. The computer program product according to claim 15, wherein said computer readable program code is configured to accept details relating to a contract between a telecom and an app developer.

25. The computer program product according to claim 24, wherein said computer readable program code is configured to incorporate details relating to usage of at least one telecom network application programming interface from within an application.
